(19) United States
(12) Patent Application Publication
(10) Pub. No.: US 2016/0060486 A1
(43) Pub. Date: Mar. 3, 2016

(54) METHOD FOR POWDER COATING A PLASTIC OR GLASS OBJECT

(71) Applicants: HOCHSCHULE OFFENBURG, Offenburg (DE); SCHNEIDER OBERLÄCHENTECHNIK GmbH, Lahr (DE)

(72) Inventors: Harald Schneider, Appenweier (DE); Johannes Vinke, Offenburg (DE); Lina Rustam, Offenburg (DE)

(21) Appl. No.: 14/782,821

(22) PCT Filed: Jan. 29, 2014
(86) PCT No.: PCT/EP2014/000243

§ 371 Date: Oct. 7, 2015

(30) Foreign Application Priority Data
Apr. 8, 2013 (DE) 102013005990.9
Sep. 18, 2013 (DE) 102013015448.0
Oct. 17, 2013 (DE) 102013017267.5

(51) Int. Cl. C09D 183/06; B05D 7/00; C08J 7/04; C03C 17/00; C03C 17/30; B05D 7/02; B05D 3/04

(52) U.S. Cl. CPC C09D 183/06; B05D 7/02; B05D 7/544; B05D 3/0413; C03C 17/006; C03C 17/30; C08J 7/042

(57) ABSTRACT

The present invention relates to a method for powder coating a plastic or glass article, comprising the steps of forming a polar coating on the plastic or glass article, including the substep of applying a coating composition to the plastic or glass article, wherein the coating composition comprises an organosiloxane having at least two Si—O bonds, water, an organic solvent, and a pH regulator selected from a Brønsted acid, in a catalytic amount, with the proviso that the coating composition contains no electrically conductive additive selected from ionic compounds, metals, (mixed) metal oxides, intermetallic compounds, and conductive carbon, and also the steps of applying a powder coating material to the thus-coated plastic or glass article, and of heating the powder coating material.

The present invention relates to a method for powder coating a plastic or glass article.

Industrial electrostatic powder coating processes find application primarily in the sanitary and household appliance industry, in radiator construction, for coatings on architectural facings, for furniture coating, and in the automobile industry. Powder coating is a coating process in which an electrically conductive material is coated with powder coating material with the assistance of electrostatic forces of attraction. Common powder coating materials comprise polymer resins, as for example epoxy resins and/or polyester resins, and also dyes/pigments and additives.

In common powder coating processes, the powder coating material is charged electrostatically, often with the assistance of a corona treatment or tribo treatment. The article to be coated—typically a metal—is grounded, and so a mirror charge is generated on the article. Through use of compressed air, the charged powder coating particles are accelerated in the direction of the article. As a result of electrostatic forces of attraction, a certain fraction of the powder coating particles striking the surface of the article remain adhering to it.

Difficulties arise in particular with articles which lack conductivity or only have a low conductivity, such as plastic articles, articles made from wood-plastic composite materials, or glass articles, for example, since in these cases, owing to the low electrostatic forces, the particles of powder coating material adhere inadequately to the article and therefore cannot be applied to a sufficient film thickness. In the past, proposals have been made first to increase the electrostatic forces between the surface of such an article and the powder coating particles through application of a coating comprising a conductive additive. A conductive additive may be soluble in water or in an organic solvent. Examples of these are, in particular, ionic compounds—for example, inorganic salts, such as sodium chloride. Conductive additives may also be insoluble particulate solids with different shapes and sizes.

Conductive additives of this kind include metals, in which case the metal may be selected from any desired conductive metal, such as silver, copper or iron, aluminum, chromium, tin, nickel, titanium, and mixtures thereof, for example, and (mixed) metal oxides, such as indium tin oxide (ITO. In₂O₃:Sn), aluminum zinc oxide (AZO, ZnO:Al), antimony tin oxide (ATO, SnO₂:Sb), for example, or fluorine-doped tin oxide (FTO, SnO₂:F), tin oxide, antimony pentoxide, intermetallic compounds such as borides and carbides, and also conductive carbon, such as graphite, carbon fibers, carbon nanofibers and/or carbon nanotubes, for example.

However, coatings of this kind which include a conductive additive frequently have disadvantages in terms of the adhesion and/or uniformity of the resulting coating, the brightness and/or color properties of the resulting powder coating.

EP 1 361 257 A1 describes a powder coating method for articles with low conductivity. A powder coating material is used in the method that comprises an electrically conductive additive, thereby achieving improved coating properties for the powder coating material. Not envisaged therein are measures for raising the electrical conductivity of the surface of an article to be coated. A disadvantage of this method is that the use of a conductive additive is expensive and associated with increased technical effort and complexity.

EP 2 450 109 A1 describes a powder coating method in which in a first step an article is heated to a temperature, the temperature lying above the melting point of a powder coating material that is applied in a second step, thereby forming a tacky surface. In a further step, the powder coating is cured using infrared radiation. No conductive additive is added. The adhesion of the powder coating material to the substrate is achieved through a kind of melt bonding of the powder coating material on the heated article, and not by electrostatic forces of attraction.

Accordingly it is an object of the present invention to provide an innovative method for the powder coating of a plastic or glass article, this method being inexpensive, eco-friendly, and easy to integrate into existing production processes, and allowing a powder coating of high quality to be produced without the use of a conductive additive.

This object is achieved by the embodiments characterized in the claims.

Provided more particularly is a method for powder coating a plastic or glass article, comprising the following steps:

the forming of a polar coating on the plastic or glass article,
comprising the substeps of aging a coating composition for a duration of at least 12 hours and of applying the coating composition to the plastic or glass article,
the applying of a powder coating material to the thus-coated plastic or glass article, and the heating of the powder coating material to a temperature of 100 to 250° C., wherein the coating composition comprises an organosiloxane having at least two Si—O bonds, water, an organic solvent, and a pH regulator, selected from a Brønsted acid, in a catalytic amount, with the proviso that the coating composition contains no electrically conductive additive selected from ionic compounds, metals, (mixed) metal oxides, intermetallic compounds, and conductive carbon.

The plastic or glass article which is subjected to the method of the invention is not covered by any particular restriction.

In accordance with the invention, the term “glass article” encompasses not only articles which consist exclusively of a glass, but also composite materials which consist at least partly of glass. Examples of glass articles suitable for the powder coating method of the invention include flat glass, household glasses such as wine vessels and other drinking vessels, cans, vases, and the like. The composition of the glass present in the glass article is not subject to any particular restriction. Glasses suitable for the method of the invention may be manufactured from a multiplicity of different types of glass, such as, for example, borosilicate glass, fused quartz, crown glass, lime-soda glass, float glass, flint glass, lead-crystal glass, crystal glass, and glass-ceramics such as Ceran®, for example.

Although preferably nonconductive glass articles are powder coated with the method of the invention, it is also possible for conductive glass articles to be used (for example, indium tin oxide (ITO)-coated glass). As observed above, a coating with increased polarity is produced on the glass article before a powder coating material is applied. This is advantageous even in the case of glass articles having a certain electrical conductivity, since the formation of the polar coating allows the (surface) polarity of the glass article to be increased. Conductive glass articles in this context are held to be those having a surface resistivity of not more than 10¹³ Ωm. The conductivity of the coating composition envisaged in accordance with the invention, intended for application and giving rise to sufficient (surface) polarity, is approximately 2 μS/cm (measured with a conductivity electrode). The resistance accordingly would be 5×10⁹ Ωm.

Before the application of the coating composition, the surface of the glass article may optionally be pretreated. In this case the surface of the glass article may be pretreated preferably by a cleaning process, such as by ultrasound, aqueous surfactant solutions, solvents, solvent mixtures, or CO₂ treatment, for example. Maximizing the cleanness of the surface of the glass article results in the effective adhesion of the coating and, as a result of this, ensures a uniform powder coating with firm adhesion and high durability. Other pretreatment measures are flaming, etching, roughening or heat-treating (for example, ˜70° C./24 h).

In accordance with the invention, the term “plastic article” includes not only articles which consist exclusively of a plastic, but also composite materials, such as wood-plastic composite materials, for example. The plastic article comprises one or more plastics, and optionally plastics with further components of metal, wood, and other common materials. Examples of plastic articles which are suitable for the powder coating method of the invention include handles, heaters, toys, sports equipment, interior automobile trim components, etc. The plastic included in the plastic article is not subject to any particular restriction, and encompasses organic polymers and/or copolymers, and also blends thereof. The plastic article preferably comprises at least one organic polymer selected from the group consisting of polyamide, polyurethane, polyethylene terephthalate, polyolefin, polystyrene, acrylonitrile-butadiene-styrene terpolymer (ABS), polybutylene terephthalate (PBT), polyethylene terephthalate (PET), polycarbonate (PC), polyoxymethylene (POM), polyvinyl chloride (PVC). and polymethyl methacrylate (PMMA), and also blends thereof, and the plastic may optionally be a carbon fiber-reinforced and/or graphite-reinforced and/or glass fiber-reinforced plastic.

Although preferably nonconductive plastic articles are powder coated with the method of the invention, it is also possible for conductive glass articles to be used. As observed above, a coating with increased polarity is produced on the plastic article before a powder coating material is applied. This is advantageous even in the case of plastic articles having a certain electrical conductivity, since the formation of the polar coating allows the (surface) polarity of the plastic article to be increased. Conductive plastic articles in this context are held to be those having a surface resistivity of not more than 10¹³ Ωm. The conductivity of the coating composition envisaged in accordance with the invention, intended for application and giving rise to sufficient (surface) polarity, is approximately 2 μS/cm (measured with a conductivity electrode). The resistance accordingly would be 5×10⁹ Ωm.

The plastic included in the plastic article may be either a heat-sensitive plastic or a heat-stable plastic. In this context, plastics having a glass transition temperature, Tg, of −20° C. up to a melting temperature, Tm, of 250° C. are considered to be heat-sensitive. When using a heat-sensitive plastic (article), the step of the heating of the powder coating material in the method of the invention takes place preferably in the low-temperature range from 120° C. to 150° C. Furthermore, when using a heat-sensitive plastic article, preference is given to using a powder coating material which is already crosslinkable at a temperature of at least 120° C. In the case of powder coating, the crosslinking of the powder coating material is also referred to as baking.

Before the application of the coating composition, the surface of the plastic article may optionally be pretreated. In this case the surface of the plastic article may be pretreated preferably by a cleaning process, such as by ultrasound, aqueous surfactant solutions, solvents, solvent mixtures, or CO₂ treatment, for example.

Maximizing the cleanness of the surface of the plastic article results in the effective adhesion of the coating and, as a result of this, ensures a uniform powder coating with firm adhesion and high durability. Other pretreatment measures are flaming, etching, roughening or heat-treating (for example, ˜70° C./24 h).

The step of the forming of a sufficiently polar coating on the plastic or glass article comprises two substeps: aging the coating composition for a duration of at least twelve hours, preferably 24 hours, more preferably 48 hours, and applying the coating composition to the plastic or glass article.

In accordance with the invention, the coating composition used comprises an organosiloxane having at least two Si—O bonds, water, an organic solvent, and a pH regulator, selected from a Brønsted acid, in a catalytic amount, with the proviso that the coating composition contains no electrically conductive additive selected from ionic compounds, metals, (mixed) metal oxides, intermetallic compounds, and conductive carbon. By an electrically conductive additive is meant those ionic compounds, metals, (mixed) metal oxides, intermetallic compounds, and conductive carbon as set out at the outset, i.e., metals, such as silver, copper or iron, aluminum, chromium, tin, nickel, titanium, and mixtures thereof, for example, and (mixed) metal oxides, such as indium tin oxide (ITO, In₂O₃:Sn), aluminum zinc oxide (AZO, ZnO:Al), antimony tin oxide (ATO, SnO₂:Sb), for example, or fluorine-doped tin oxide (FTO, SnO₂:F), tin oxide, antimony pentoxide, intermetallic compounds such as borides and carbides, and also conductive carbon, such as graphite, carbon fibers, carbon nanofibers and/or carbon nanotubes, for example. The coating composition preferably comprises more than 1 to less than 3 mol of water per mol of Si atoms in the organosiloxane (i.e., 1<r<3, see below), 10 to 50 parts per weight, more preferably 20 to 40 parts per weight, of organic solvent, per 100 parts by weight of the organosiloxane, and 0.001 to 0.1 mol, more preferably 0.003 to 0.05 mol, of pH regulator per mole of Si—O bonds of the organosiloxane. At the beginning of aging, the coating composition is preferably in the form of a solution.

The aging of the coating composition is not subject to any particular restriction and takes place for a duration of at least 12 hours, preferably at least 24 hours, more preferably at least 48 hours, such as not less than four or five days, for example. Aging is carried out preferably under standard conditions. During aging, a multistage polycondensation reaction takes place in the coating composition (which may also be referred to as “sol”), with the formation of a polyorganosiloxane. Reactions of this kind are referred to generally as sol-gel processes. When the polycondensation reaction is advanced or has concluded, the coating composition may be referred to as a “gel”. The formation of the polyorganosiloxane from the organosiloxane is based on substantially three equilibrium reactions: hydrolysis/etherification, alcohol condensation/alcoholysis, and water condensation/hydrolysis. Hydrolysis of Si—O-alkyl bonds produces Si—OH groups, which subsequently permit condensation reactions. In alcohol condensation and water condensation, Si—O—Si groups are formed. If alcohol condensation and water condensation are continued, polyorganosiloxanes are formed. An increased concentration of the Si—OH groups in the coating composition leads to a polar coating on the glass article, this coating furnishing improved powder coating properties, more particular an improved adhesion of the powder coating material to the plastic or glass article, because of an increased (surface) polarity. The concentration of the Si—OH groups correlates with the (surface) polarity of the coating, in that the concentration of the Si—OH groups in the coating composition goes up in line with the duration of the aging step.

The amount-of-substance ratio of water molecules to Si atoms (H₂O:Si) in the coating composition is termed the r value. In the case of substochiometric reactions (r<2), alcohol condensation takes place preferentially instead of water condensation; in the case of superstochiometric reactions (r>2), water condensation takes place preferentially rather than alcohol condensation. A further factor is that a high r value accelerates the sol-gel process. However, at r≧3, sufficiently wettability of the surface of the glass article is no longer ensured, and so preferably r<3. More preferably 1.2≦r<2.0, and especially preferably 1.5≦r≦1.7. When r is within the stated ranges, not only is sufficient wettability of the surface of the glass article ensured, but alcohol condensation is promoted as well, while the condensation of water is suppressed. Water formed in water condensation is especially deleterious for the later step of applying the powder coating material. Furthermore, a shift in the equilibrium of the twin alcohol condensation/alcoholysis reactions in favor of the alcoholysis leads to an increased concentration of Si—OH groups, which is an advantage for the powder coating properties of the polar coating (adhesion of the powder coating material by virtue of increased (surface) polarity).

The aged coating composition comprises a polyorganosiloxane which has repeating units having at least two Si—O bonds (—[Si—O]ₙ—, where n is a whole number greater than 1).

In one preferred embodiment of the method of the invention, the coating composition comprises a flow assistant. The proportion of the flow assistant is preferably 90-50 wt %, more preferably 80-60 wt %, based on the total mass/total amount of substance of the coating composition. Through the use of a flow assistant in the coating composition it is possible to adjust the desired thickness of the coat on the plastic or glass article that is formed by the coating composition (wet film thickness). The flow assistant is not subject to any particular restriction. Examples of flow assistants which can be used advantageously in the coating composition are, in particular, alcohols. A particularly preferred flow assistant is ethanol.

In another preferred embodiment, the coating composition comprises a leveling assistant. The proportion of the leveling assistant is preferably 0.5 to 10 wt %, more preferably 0.5 to 5 wt %. Leveling assistants used may be, for example, talc, feldspar, and kaolin, with kaolin being used preferably. Occasionally the polar coating may exhibit irregularities in coating thickness, visible edges or ridges. Irregularities of this kind may occur particularly on the underside of the article to be coated, as a result of the effect of gravity after the coating composition has been applied. Adding a leveling assistant to the coating composition allows this unwanted effect to be counteracted.

In the method of the invention, the coating composition is applied preferably in a film thickness of 15 μm to 30 μm, more preferably of 15 μm to 25 μm.

In the above-described sol-gel process which occurs in the course of the aging, the pH regulator acts as a catalyst. This shortens the duration of the aging needed in order to obtain a polar coating having sufficiently good powder coating properties. In general a sol-gel process can be carried out even without catalyst. However, that would necessitate a duration of aging of more than one week in order to obtain a conductive coating having sufficiently good powder coating properties.

The coating composition used in accordance with the invention contains no electrically conductive additive. As already elucidated above, the aging of the coating composition for a duration of at least twelve hours is able to ensure that the resulting polar coating has outstanding coating properties, more particularly an excellent adhesion of the powder coating material to the surface of the polar coating on the plastic or glass article. Through at least twelve-hour aging of the coating composition, a sufficiently polar coating is provided, with a high (surface) polarity suitable for subsequent powder coating. It is therefore unnecessary to condition the coating further, by means of a conductive additive, for the subsequent powder coating procedure.

Given that the conductive additives used in general are usually insoluble, coating compositions which include such additives generally take the form of a dispersion (suspension, emulsion). Such dispersions are frequently stabilized by means of a dispersant (suspension agent, emulsifier), since otherwise the insoluble particles (commonly particulate solids) would form sediment or there would be otherwise-separate phases present. In contrast to this, the coating composition used in accordance with the invention is present (at least at the beginning of aging) preferably in the form of a solution. Furthermore, the coating composition used in accordance with the invention preferably does not contain any dispersant.

The organosiloxane having at least two Si—O bonds is not subject to any particular restriction. The presence of at least two Si—O bonds ensures that the organosiloxane is able to condense with formation of a polyorganosiloxane. The organosiloxane preferably has four, more preferably three, Si—O bonds. The Si—O bonds are formed preferably between the silicon atom (Si) and a substituent —O—R, with R preferably being selected from the group consisting of an alkyl group having 1 to 6 carbon atoms, an alkenyl group having 1 to 6 carbon atoms, an alkynyl group having 1 to 6 carbon atoms, an aryl group, a heteroaryl group, an acyl group having 1 to 6 carbon atoms, a fluoroalkyl group having 1 to 6 carbon atoms, and the substituents —O—R may be different from one another. Preferably R is a linear alkyl group having 1 to 4 carbon atoms, more preferably an ethyl or a prop-1-yl group.

Independently of this, the organosiloxane, in a radial R′ for example, giving the organosiloxane the formula R′—Si(OR)₃, preferably has a crosslinkable group, which with particular preference is terminal. The presence of a crosslinkable group allows the coating composition to form a further polymer structure as well as forming a polyorganosiloxane. By this means it is possible to endow both the polar coating and the powder coating with a particular stability. The crosslinkable group may be, for example, an epoxide group, an acrylic group, a vinyl group, an aryl group, or an amino group. The crosslinkable group is preferably an epoxide group. The radical R′ is preferably a glycidyloxyalkyl radical, such as a glycidyloxymethyl, glycidyloxyethyl, glycidyloxypropyl, or glycidyloxybutyl radical, for example, more preferably a glycidyloxypropyl radical. Siloxanes used with preference in accordance with the present invention are glycidyloxyalkyltrialkoxysilanes, such as glycidyloxypropyltriethoxysilane, for example.

The water used in accordance with the invention is not subject to any particular restrictions. Preferably the water is demineralized.

The organic solvent used in accordance with the invention is not subject to any particular restrictions. The presence of the solvent in the coating composition allows phase separation to be avoided, particularly in the initial phase of aging. Under standard conditions, the solvent is preferably miscible with water. Solvents used may be, for example, acetone, dialkyl ethers (for example, diethyl ether), dimethylformamide, N-methylpyrrolid-2-one, ethyl acetate, benzene, n-alkanols having 1 to 4 carbon atoms, or mixtures thereof. Preferred solvents are alcohols having 1 to 4 carbon atoms, such as ethanol, propan-2-ol, propan-1-ol, n-butan-1-ol, and butan-2-ol, for example. A particularly preferred solvent is ethanol. Alcohols, especially ethanol, may therefore function as solvents and as flow assistants.

In one preferred embodiment of the method of the invention, the organosiloxane has three identical substituents —O—R, with the corresponding alcohol H—O—R being used as solvent. Accordingly, a combination can be used of an organosiloxane R′—Si(OR)₃ with an organic solvent R—OH, and R may be, for example, methyl, ethyl, prop-1-yl, prop-2-yl, n-but-1-yl, or but-2-yl. In the case of this embodiment, R is more preferably ethyl. Where an alcohol is used as organic solvent, there may be a transesterification of the alcohol with the group —O—R of the organosiloxane. Any unwanted effects resulting from this can be ruled out in accordance with the above-elucidated preferred embodiment of the method of the invention.

The coating composition used in accordance with the invention further comprises a Brønsted acid as pH regulator. Examples of Brønsted acids are hydrochloric acid, nitric acid, sulfuric acid, acetic acid, and trifluoroacetic acid. The pH of the coating composition prior to aging is preferably between 0.5 and less than 5, more preferably between 2 and 4; for example, before aging, the coating composition has a pH of 1.5. In the event the organosiloxane has an Si—C bond, an acidic catalyst is advantageous, since in that case the duration of the aging step can be lowered further by acid catalysis than by basic catalysis.

The appearance and also the elasticity of the powder coating materials for application can be improved further by addition of bisphenol A, more particularly by addition of bisphenol A in combination with histidine, to the coating composition used in accordance with the invention.

The applying of the coating composition is not subject to any particular restriction and may take place in any conceivable way, as for example by dipping, brushing, and spraying methods, knife coating, printing, rotational coating, (spray) painting, slot-die coating, roll coating, cascade coating, or curtain coating. The coating composition may also be applied through a combination of different techniques. The coating composition is applied preferably by spraying, since in that case the coating composition can be applied very evenly and with a uniform film thickness to the plastic or glass article.

The aging of the coating composition begins as soon as the composition is provided, i.e., produced. With regard to a simple and efficient process design it is advantageous in accordance with the invention to carry out the aging of the coating composition before it is applied to the plastic or glass article. One of the effects of this is to minimize the risk of possible contamination of the surface of the plastic or glass article during aging. It is possible, furthermore, when aging is carried out before the coating solution is applied, to implement the method of the invention efficiently and in one move.

While simple flashing of the coating at room temperature after its application is possible, a preferred embodiment of the present invention nevertheless involves, after the application and aging of the coating composition and before the application of the powder coating material, the heating of the coating composition for a duration of 5 seconds to 10 minutes to a temperature of 80 to 150° C., preferably for a duration of 30 seconds to 5 minutes to a temperature of 100 to 140° C., as for example for a duration of one minute to a temperature of 120° C. The heating may take place in principle in any desired way, as for example by forced air, or electromagnetic radiation such as infrared radiation and/or laser beams. As a result of this heating, residual solvent and/or water are removed at least partly from the coating. In addition, this heating allows the crosslinking of any crosslinkable group present in the (poly)siloxane, such as an epoxide group, for example, thereby making it possible to obtain greater stability in the polar coating and in the powder coating.

The applying of the powder coating material is not subject to any particular restriction and may take place in any conceivable way. The powder coating material is preferably applied by electrostatic spraying to the coated plastic or glass article. The electrostatic spraying commonly takes place by means of spray guns which operate with corona or tribo assistance.

The powder coating material used in accordance with the invention is not subject to any particular restriction. Powder coating materials normally comprise a solid, thermoplastic or thermosettable, film-forming polymer resin. A multiplicity of different types of thermoplastic resins for powder coating materials are known, examples being vinyl chloride, polyamides, polycelluloses, polyolefins, polyethylene, and polyesters. Thermosettable, film-forming resins comprise reactive functional groups, if desired an optional curing agent (crosslinking agent) having functional groups which are reactive with the functional groups of the polymer resin, and which themselves are a different film-forming polymer, and optionally a catalyst. Known thermosettable resins include acid-functional polyester resins, acid-functional acrylic acid resins, epoxy resins, and hydroxy-functional polyester resins, but are not confined to these. The powder coating material used preferably has an average particle size of 0.5 to 100 μm as determined by classification.

In accordance with the present invention it is possible to use thermosettable powder coating materials which cure at low temperature. Powder coating materials which cure at low temperatures cure generally at temperatures of less than 170° C., preferably less than 150° C., most preferably less than 135° C. Examples of thermosettable powder coating materials which cure at low temperature include epoxy powders and mixed epoxy-polyester powders, of the kind known to a skilled person.

The heating of the powder coating material is not subject to any particular restrictions and may take place in the same way as or in a different way from the optional heating of the coating composition. The heating of the powder coating material may take place in principle in any desired way, by means of forced air, electromagnetic radiation such as ultraviolet, infrared and/or microwave radiation, for example.

According to one preferred embodiment of the invention, the heating of the powder coating material takes place by forced air in a forced air oven. Through a forced air oven it is possible to process a high throughput of glass articles easily, cost-effectively, and efficiently. Heating in a forced air oven is suitable particularly for plastic or glass articles which are not heat-sensitive, but may also be used optionally for heat-sensitive plastic or glass articles. In the case of heat-stable plastic or glass articles, the powder coating material is heated preferably to a temperature of 150 to 250° C., more preferably 180 to 220° C.

According to another preferred embodiment of the invention, the heating of the powder coating material takes place through use of infrared and/or ultraviolet radiation. Heating of the powder coating material in this way allows it to be heated selectively and gently, so that the plastic or glass article located beneath the powder coating material heats up to a lesser extent than the powder coating material. Heating using infrared and/or ultraviolet radiation is suitable particularly for plastic articles which are heat-sensitive. In the case of heat-sensitive plastic articles, the powder coating material is heated preferably to a temperature of not more than 170° C., more preferably not more than 150° C., very preferably not more than 135° C.

In a further aspect, the present invention relates to a powder-coated plastic or glass article comprising in this order, from inside to outside: a plastic or glass article, a polar coating comprising an organosiloxane which comprises repeating units having at least two Si—O bonds (—[Si—O]ₙ—, where n is a whole number greater than 1), and a powder coating, with the proviso that the polar coating contains no electrically conductive additive selected from ionic compounds, metals, (mixed) metal oxides, intermetallic compounds, and conductive carbon. The powder coating on the powder-coated plastic or glass article has excellent properties such as uniform powder coating film thickness, excellent appearance, and high stability and durability.

The present invention provides an innovative, efficient method for the powder coating of a plastic or glass article, which can be integrated inexpensively, in an eco-friendly manner, and easily into existing production processes, and which allows the production of a high-quality powder coating without the use of a conductive additive. By virtue of the present invention, moreover, a powder-coated plastic or glass article is provided whose powder coating has excellent properties, such as uniform powder coating film thickness, excellent appearance, and high stability/durability.

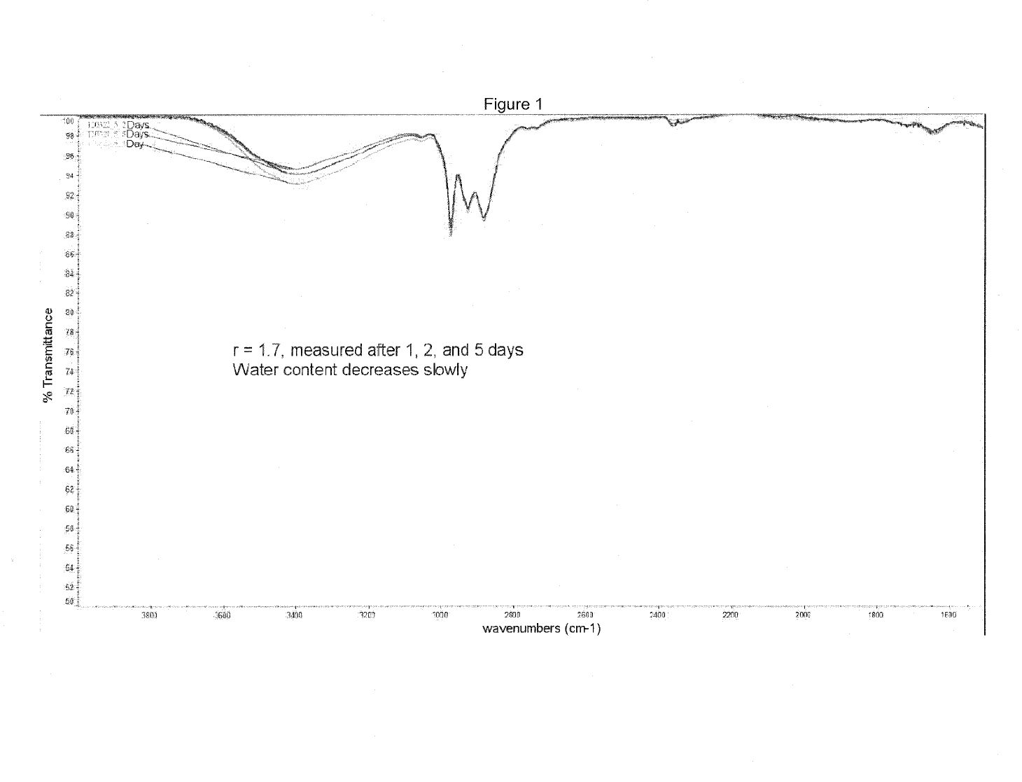

FIG. 1 shows IR spectra of a freshly prepared coating solution (r=1.7) after aging for a duration of one, two, and five days. It is evident that the water content decreases slowly.

The examples below serve as further elucidation of the present invention, without being confined thereto.

### EXAMPLE 1

Under standard conditions, 0.1 mol (27.8 g) of glycidyloxypropyltriethoxysilane (GPTES) was charged to a glass beaker, admixed with 3.06 of hydrochloric acid (0.1 N, based on the three hydrolyzable Si—O bonds of GPTES, corresponding to 0.003 mol of HCl), and stirred. Within the first 30 seconds after addition of the hydrochloric acid, an increase in the pH from an initial pH of 1.5 to 2 to a pH of 4 was observed. After that the pH remained constant. After 210 hours, the GPTES had gone completely into solution. The reaction mixture is stirred for one hour in total.

Subsequently, in different batches, 60 or 80 wt % of ethanol, based on the weight of the GPTES used, was added and the mixtures were stirred for a further five minutes. Thereafter the various batches were each aged for different times. IR spectra were recorded of solutions with different water concentrations, without the addition of ethanol.

The coating compositions, each aged for different time durations, were applied by spraying to PVC, PA6, PA12, and PP substrates, respectively. The coating on the substrates thus coated was heated in a forced air oven at 120° C. for 1 minute. After the substrates thus coated had cooled to room temperature, attempts were made in each case to apply a powder coating material (mixed polyester/epoxy powder from Beriyam) by means of a powder coating apparatus, with corona charging.

Here it was found that coating compositions aged for less than 12 hours were unsuitable for the generation of a polar, powder-coatable coating on a plastic article, since the powder coating did not properly adhere to the plastic articles coated accordingly. Very good results were observed for an aging duration of 24 hours. After four days of aging, excellent results were achieved, and could not be improved even by longer aging times.

### EXAMPLE 2

Example 2 was carried out in the same way as for example 1, with the addition first of ethanol and thereafter of hydrochloric acid. The results obtained largely corresponded to those from example 1.

### EXAMPLE 3

Example 3 was carried out in the same way as for example 1, using the following formulation:

GPTES glycidyloxypropyltriethoxysilane (GPTES):BPA (bisphenol A):HIS (histidine)

1:0.3:0.0025
0.02:0.006:0.00005 [mol]
5.56:1.3696:0.0078 [g]

Based on the amount-of-substance ratio of 0.02 mol of GPTES, 2.16 g of 0.1 N hydrochloric acid were added, which is a ratio of water:Si of r=6. These 2.16 g of 0.1 N hydrochloric acid include 0.000216 mol of HCl. A higher water content was selected, since the histidine dissolves fairly poorly.

HIS was dissolved in HCl with stirring, and then GPTES was added. The mixture was stirred for 1 hour.

Then BPA was added. When the BPA had dissolved, ethanol was added so as to give a 40 wt % solution, based on GPTES.

Also possible is a 20 wt % solution, based on GPTES.

### EXAMPLE 4

Under standard conditions, 69.50 g of 3-glycidyloxypropyltriethoxysilane (GPTES) were charged to a mixing vessel with magnetic stirrer, 7.65 g of hydrochloric acid (0.1 N) were added, and the mixture was stirred for 1 h, with the magnetic stirrer being adjusted such that no air bubbles were formed. Then 193.2 g of ethanol were added and the mixture was stirred for five minutes more.

The composition aged accordingly was then used to coat glass articles by spraying.

### EXAMPLE 5

Example 2 was carried out in the same way as for example 1, using the following formulation:

69.50 g of 3-aminopropyltriethoxysilane
7.65 g of hydrochloric acid (0.1 N)
193.2 g of ethanol

1. A method for powder coating a plastic or glass article, comprising the following steps:
the forming of a polar coating on the plastic or glass article, comprising the substeps
of aging a coating composition for a duration of at least 12 hours and of applying the coating composition to the plastic or glass article,
the applying of a powder coating material to the thus-coated plastic or glass article, and
the heating of the powder coating material to a temperature of 100 to 250° C., wherein the coating composition comprises an organosiloxane having at least two Si—O bonds, water, an organic solvent, and a pH regulator, selected from a Brønsted acid, in a catalytic amount,
with the proviso that the coating composition contains no electrically conductive additive selected from ionic compounds, metals, (mixed) metal oxides, intermetallic compounds, and conductive carbon.

2. The method as claimed in claim 1, wherein the coating composition, after the aging and applying of the composition and before the applying of the powder coating material, is heated to a temperature of 80 to 150° C. for a duration of 5 seconds to 10 minutes.

3. The method as claimed in claim 1, wherein the aging of the coating composition takes place for a duration of at least 24 hours, preferably 48 hours.

4. The method as claimed in claim 1, wherein the coating composition comprises a flow assistant.

5. The method as claimed in claim 1, wherein the heating of the powder coating material takes place by use of infrared or ultraviolet radiation.

6. The method as claimed in claim 1, wherein the heating of the powder coating material takes place in a forced air oven.

7. The method as claimed in claim 1, wherein the glass article comprises at least one glass selected from the group consisting of borosilicate glass, fused quartz, crown glass, lime-soda glass, float glass, flint glass, lead-crystal glass, crystal glass, and glass-ceramic.

8. The method as claimed in claim 1, wherein the glass article is a composite material comprising glass.

9. The method as claimed in claim 1, wherein the plastic article comprises at least one plastic selected from the group consisting of polyamide, polyurethane, polyethylene terephthalate, polyolefin, polystyrene, acrylonitrile-butadiene-styrene terpolymer (ABS), polybutylene terephthalate (PBT), polyethylene terephthalate (PET), polycarbonate (PC), polyoxymethylene (POM), polyvinyl chloride (PVC), and polymethyl methacrylate (PMMA), and also blends thereof, the plastic optionally being a carbon fiber-reinforced and/or graphite-reinforced and/or glass fiber-reinforced plastic.

10. The method as claimed in claim 1, wherein the plastic article is a wood-plastic composite material.

11. The method as claimed in claim 1, wherein the coating composition comprises 0.5 to 10 wt % of a leveling assistant.

12. The method as claimed in claim 11, wherein the leveling assistant is selected from kaolin, talc and/or feldspar, preferably from kaolin.

13. A powder-coated plastic or glass article comprising in this order, from inside to outside:
a plastic or glass article,
a polar coating comprising a polyorganosiloxane which contains repeating units having at least two Si—O bonds, and
a powder coating,
with the proviso that the polar coating contains no electrically conductive additive selected from ionic compounds, metals, (mixed) metal oxides, intermetallic compounds, and conductive carbon.
